(19) United States
(12) Patent Application Publication
(10) Pub. No.: US 2015/0016294 A1
(43) Pub. Date: Jan. 15, 2015

(54) LINK AGGREGATION APPARATUS

(71) Applicant: Stephan Hegge, Minato (JP)

(72) Inventor: Stephan Hegge, Minato (JP)

(73) Assignee: FUJITSU LIMITED, Kawasaki-shi, Kanagawa (JP)

(21) Appl. No.: 14/388,826

(22) PCT Filed: Mar. 30, 2012
(86) PCT No.: PCT/JP2012/002249

§ 371 Date: Sep. 29, 2014

(51) Int. Cl. H04L 12/26; H04L 12/709

(52) U.S. Cl. CPC H04L 43/0852; H04L 43/0829; H04L 45/245
USPC 370/252

(57) ABSTRACT

A timeout value determining method of a link aggregation apparatus includes receiving link aggregated packets from a plurality of links, the link aggregated packets flowing on a packet flow between two end hosts, determining a delay relating to a remote host within the two end hosts, reordering the link aggregated packets based on an order in the packet flow, and calculating, by using a processor, a timeout value corresponding to each of the links based on a packet loss and the delay, each timeout value is used to wait reception of a packet from a corresponding link.

### TECHNICAL FIELD

The present invention relates to a link aggregation apparatus.

### BACKGROUND ART

To improve indoor mobile wireless coverage for home or enterprise usage and improve the overall capacity of the mobile wireless network, femtocells (small base stations) are currently being developed and deployed. As a backhaul connection to the mobile wireless network operators, the femtocells use the existent internet connection of the user, for example and an Asymmetric Digital Subscriber Line (ADSL) or fiber internet connection.

It is thought that in the future, femtocells will not only provide a 3G (3rd-Generation) or 4G (4th-Generation) or a similar cellular technology to the deploying customer, but will also provide access to the home network through other wireless connection technologies like IEEE802.11 or Bluetooth (Registered Trademark) etc. Because every wireless communication technology can be used independently of the other, the wireless communication technologies (connection technologies) can be combined to provide a faster total bandwidth. The provision of the faster total bandwidth can be achieved by using a technique called packet link aggregation, which combines both links and divides packets transported over a network between wireless links available to a host.

### CITATION LIST

### Patent Literature

[PTL 1] Patent JP 2001-345718 A

### SUMMARY

### Technical Problem

When using packet link aggregation on wireless links, it is believed to be necessary to employ some form of packet reordering when combining the packets split over several wireless links together. Due to the highly variable nature of wireless technologies (caused by interference or movement of the transmission/reception device) there is a high variance on the arrival of packets on a link. For example, there might be a burst of correctly received packets followed by a short interval of no transmission (due to transmission errors) followed by a slower reception of packets. This high variability usually does not intervene much when using only one link. However, when packets of a same transmission flow (e.g. TCP/IP (Transmission Control Protocol/Internet Protocol) flow) are split among various wireless links, out of order arrivals occurring due to the variability of the wireless links have a very large performance impact on the TCP flow. The performance impact is caused by the fact that TCP acknowledges packets by sequence numbers. If some sequence number arrives before another and if the intermediate packets do not arrive within a certain timeframe, TCP will consider these packets as lost. When these packets are considered lost, TCP will send a retransmission request to sending host, which will consequently lower its transmission speed.

It is assumed that a relay apparatus (link aggregation point: LA point) receives TCP packets from two wireless links divided by a mobile terminal has a connection to an end host. The LA point combines the TCP packets again to one flow. In the LA point, there is a probability that packets from one wireless link arrive earlier than packets from the other wireless link. Then the LA point performs some sort of packet reordering before the packets are forwarded to the end host. When performing packet reordering, the LA point sets a timer having a value for timeout for waiting for some packets which will arrive late. When the timer is expired, the packets which will arrive late are ignored (dropped).

A fixed value (a universal value) is applied to the value for timeout. The universal value causes problems which will be explained below. Namely, a performance of TCP highly depends on the round trip time of a connection. For example, an end host is located within a local area network, sub 10 ms, round trip times allow for a high throughput speed of TCP while high (long) round trip times for an end host located overseas prevents a high throughput speed for TCP. If a low (short) round trip time in the local area network would drastically increase due to a high timeout value for packet reordering, a throughput drop would be observed when using packet link aggregation. The same can be observed when the end host is located overseas. If a low timeout value would be used, packets might unnecessarily be dropped thus reducing the throughput instead of increasing it.

As mentioned above, the universal time for timeout invites reducing the throughput. Furthermore, the universal time for timeout exerts influences on upper layer and has possibility of inviting deterioration of a communication performance.

It is an object of an aspect of the present invention to provide a technique of improving a performance of link aggregation of TCP packets.

### Solution to Problem

The aspect of the present invention is a link aggregation apparatus. The link aggregation apparatus includes at least two receiver to receive link aggregated packets from a plurality of wireless links, the link aggregated packets flowing on a packet flow between two end hosts and a processor to execute processes including determining a delay relating to a remote host within the two end hosts, reordering the link aggregated packets based on an order in the packet flow, and calculating a timeout value corresponding to each of the wireless links based on a packet loss and the delay, each timeout value is used to wait reception of a packet from a corresponding wireless link.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### Advantageous Effects of Invention

According to the aspect of the present invention, a technique of improving a performance of link aggregation of TCP packets is provided.

### BRIEF DESCRIPTION OF DRAWINGS

FIG. 1 is a diagram illustrating a network system employing a link aggregation apparatus (LAA) relating to an embodiment of the present invention.

FIG. 2 is a diagram illustrating an example for configuration of the LAA.

FIG. 3 is a flow chart illustrating an example of the timeout determining process.

FIG. 4 is a diagram illustrating a table storing destination and delay.

FIG. 5 is a diagram illustrating a table storing the number of hops and delay.

### DESCRIPTION OF EMBODIMENTS

Embodiments of the present invention are described below with reference to the drawings. Configurations of the embodiments are given as examples, and any aspects of the present invention are not limited to the configurations of the embodiments.

<Network System>

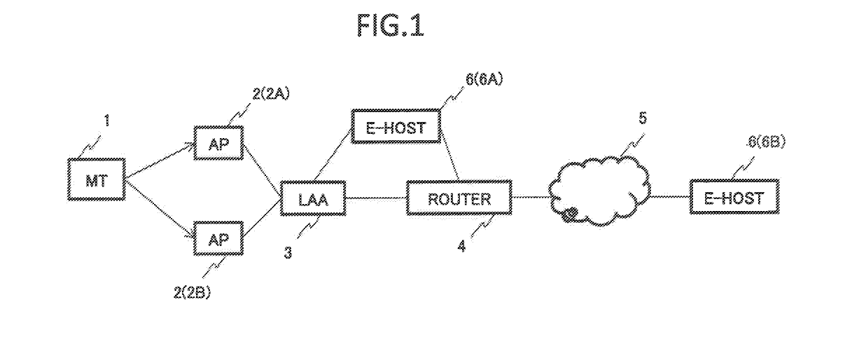

FIG. 1 illustrates a network system employing a link aggregation apparatus relating to an embodiment of the present invention. In FIG. 1, the network system includes a mobile terminal (MT) 1, access points (AP: base stations) 2 (2A and 2B), a link aggregation apparatus (LAA) 3, a router (or Layer 3 switch (L3 SW)) 4, an IP network 4, and end hosts 6 (6A and 6B).

The MT 1 is a wireless terminal supporting at least architecture of 3G or 4G (e.g. Long Term Evolution (LTE)) applied to cellar phone terminals, IEEE802.11 for wireless LAN, and Bluetooth (registered trademark). The MT 1 may perform TCP communication with an end host by employing one of the plurality of wireless communication methods (radio access technologies).

Each of the end hosts 6 illustrated in FIG. 1 is, for example, one of a server machine, a personal computer (PC), and a relay device (e.g. router) functioning as a correspondent node of the MT 1. In the example illustrated in FIG. 1, it is assumed that the end host (E-HOST) 6A and the end host (E-HOST) 6B are servers. The end host 6A is in a local area network (LAN) to which the LAA 3 belongs while the end host 6B is coupled to the LAA 3 via the IP network 5. For example, the end host 6B is located in a remote area (oversea). A packet flow is established between the MT 1 and the end host 6A or 6B, then the MT 1 is one of two end hosts and the end host 6A or 6B is another end host corresponding to a remote host.

The APs 2A and 2B respectively support one of the above-mentioned radio access technologies. In the example illustrated in FIG. 1, the AP 2A provides a femtocell for the MT 1. The AP 2B provides a general cell supporting 3G or 4G.

Further, the MT 1 supports a packet link aggregation technique, namely, in a case where an uplink communication from the MT 1 to the end host (e.g. end host 6A or 6B) is performed, the MT 1 switches or sorts packets on one TCP packet flow on to one wireless link between the MT 1 and the AP 2A (a wireless link #1) and another wireless link between the MT 1 and the AP 2B (a wireless link #2).

The LAA 3 receives TCP packets arriving from the wireless links #1 and the wireless link #2 and performs reordering the received TCP packets to make an original single packet flow. The TCP packets on the packet flow restored by the LAA 3 are forwarded to a destination thereof. If the destination is the end host 6A, the TCP packets reach the end host 6A which is in the same network. On the other hand, if the destination is the end host 6B, the TCP packets reach the end host 6B through the router 4 and the IP network 5.

Thus, the MT 1 becomes a packet link aggregation point 1 (LA point 1) and the LAA 3 becomes a LA point 2 and vice versa (If a downlink communication from the end host to the MT 1 is performed, the LAA 3 performs switching or sorting process and The MT 1 performs combining and reordering process as mentioned above).

The LAA 3 performs reordering according to sequence numbers of the TCP packets. When some TCP packets from one of the wireless links #1 and #2 have already reach The LAA 3, if some TCP packets from the other one of the wireless links #1 and #2 do not reach yet, the LAA 3 sets a timer having a timeout value to wait arriving of the TCP packets.

<Configuration of LAA>

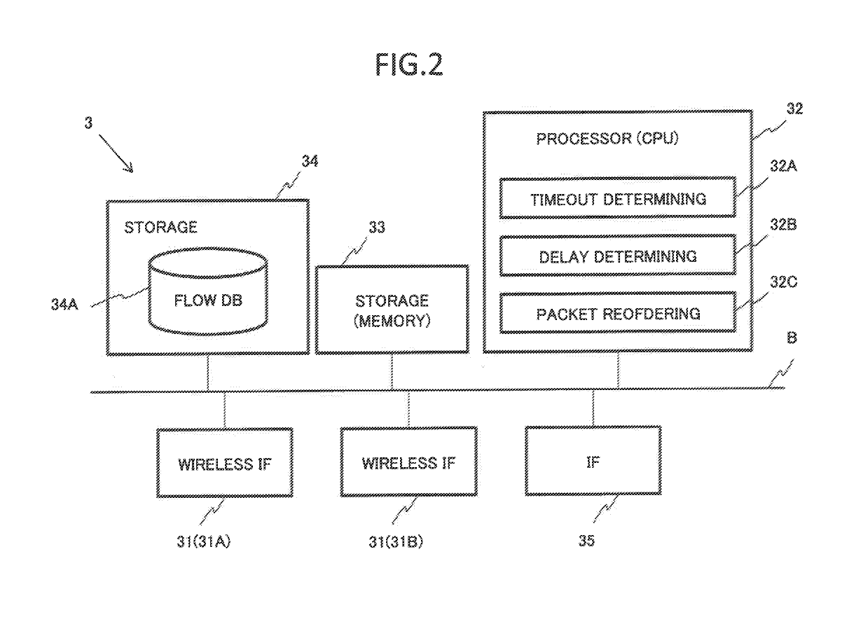

FIG. 2 illustrates an example for configuration of the LAA 3. In FIG. 2, the LAA 3 is a relay device such as a base station (e.g. a base station making a femto cell), a router, a L3 switch, or a Layer 2 switch (L2 SW). The LAA 3 includes wireless interfaces 31, a processor 32, a storage device 33, a storage device 34, and a communication interface 35. These components 31 to 35 of the LAA 3 are connected by a bus B each other. The processor 32 is one example of a controller or a control device.

The wireless interfaces 31 include circuit(s) to receive/transmit TCP packets from/to the APs 2. FIG. 2 illustrates the wireless interface (wireless IF) 31A coupled to the AP 2A and the wireless interface (wireless IF) 31B coupled to the AP 2B. The communication interface (IF) 35 include a circuit to receive/transmit TCP packets from/to the router 4 and the end host 6A. The wireless interfaces 31 are one example of at least two receivers.

The storage 33 includes a main memory containing Random Access Memory (RAM) and Read Only Memory (ROM). The main memory is used as a work area for the processor 32. The storage 34 includes is configured by an involatile storage device such as hard disc, flash memory, or Electrically Erasable Programmable Read-Only Memory (EEPROM). The storage 34 stores (holds) a database (a flow DB 34A) which stores information for each of active links. The information includes with respect to timeout values corresponding to each of the active links. The storage 34 further stores one or more programs executed by the processor 32 and data used when executing the programs.

The processor 32 is a microprocessor such as a central processing unit (CPU) or a digital processing unit (DSP). The processor 32 loads the programs in the storage 33 and executes the programs. Thereby, the processor 32 executes various processes including at least timeout determining process 32A, delay determining process 32B, and packet reordering process 32C.

When the LAA 3 functions the LA point 2 in the uplink communication, the processor 32 determines timeout values corresponding to each of the wireless links #1 and #2 by executing the delay determining process 32B and the timeout determining process 32A. The TCP packets from the wireless links #1 and #2 are received by the wireless IF 31A and 31B and are buffered on a buffer area formed on the storage 33 and/or storage 34. The processor 32 executes the reordering process with respect to the TCP packets stored in the buffer area. Then the timeout values determined by the timeout determining process 32A are applied to wait reaching of the TCP packets from each of the wireless links #1 and #2.

Furthermore, the processor makes (restores) a packet flow by reordering and combining the TCP packets. Hereafter, a destination of the TCP packets on the packet flow is determined and the TCP packets are transmitted from the communication IF 35 to the destination (the router 4, or the end host 6A).

The timeout determining process 32A, the delay determining process 32B and the packet reordering process 32C is executed by one or more hardware instead of the processor 32. For example, the hardware is applied to Integrated Circuits (IC), Large Scale Integrated (LSI), Application Specific Integrated Circuits (ASIC), Logic Programmable Devices (LPD) such as Field Programmable Gate Array (FPGA) and combination thereof. Further, the LAA 3 may support at least two wireless interfaces but might have more interfaces available compared to FIG. 2.

<Processing in the LAA 3>

Next, it will be explained detail of processing in the LAA 3 below. The configuration example of the LAA 3 as depicted in FIG. 2 is valid for the LA point 1 (the MT 1) and the LA point 2 (the LAA 3). The wireless IF 31A and 31B receives link aggregation packets from the wireless links #1 and #2. The wireless IF 31A supports a first radio access technology and the wireless IF 31B supports a second radio access technology differing from the first radio access technology.

The processor 32 rearranges the received TCP/IP packets according to a found sequence number in the link aggregated packets. When packet(s) arrives out of order (e.g. a packet having a sequence number “2” is expected to reach next but a packet having a sequence number “3” reaches), the processor 32 puts the packets into a special buffer (waiting buffer) formed on the buffer area of the storage 33 and/or 34 and keeps the packets until the expected packets reaches or until a timeout timer expires. The timeout timer is started whenever a packet reaches out of order. The timeout timer is reset when the waiting buffer becomes empty or the timeout timer expires. For example, the timeout timer is controlled by the processor 32.

The processor 32, by executing the delay determining process 32B, obtains a delay with respect to the end host. The term of “delay” includes a physical distance in terms of number of hops to the end host or location in the network (in terms of subnet). The term of “delay” also includes distance with respect to time which a packet reaches the end host and returns from the end host to the LAA 3 (Round Trip Time: RTT) or any other means of time or space to give an indication how much time is required for a packet to travel forth and back and forth to the end host.

Based on the “delay”, the processor 32 determines per flow the most suitable timeout value for packet reordering by executing the timeout determining process 32A. The timeout value may be determined when a packet flow between two hosts (e.g. the MT 1 and the end host 6A or 6B) is established or when a packet flow between two hosts is already existent and new information with respect to the “delay” is obtained by the delay determining process 32B. A value indicating the delay is stored in the flow DB 34A.

In the delay determining process 32A, the processor 32 obtains information with respect to the flows which are being link aggregated and collects information with respect to these flows with respect to the delay to the end host. The delay may be determined by actively monitoring or determining information obtained by monitoring the packet flows. For example, when a new packet flow is established, the processor 32, by executing the delay determining process 32A, may send out a “ping” packet to the end host to determine the Round Trip Time (RTT) to the end host. Furthermore, the processor 32 may inspect the RTTs from TCP packets monitoring the TCP packets (For example, when a packet is sent to the end host and when an acknowledge packet of that same packet reaches from the end host). The processor 32 refers to various information stored in the flow DB 34A in the delay determining process 32B, the timeout determining process 32A and the packet reordering process 32C.

<Example for Determining the Timeout Value>

A first example of the timeout determining process 32A to calculate the timeout based on the RTT to the end host and the total aggregate bandwidth offered by the link aggregation interfaces.

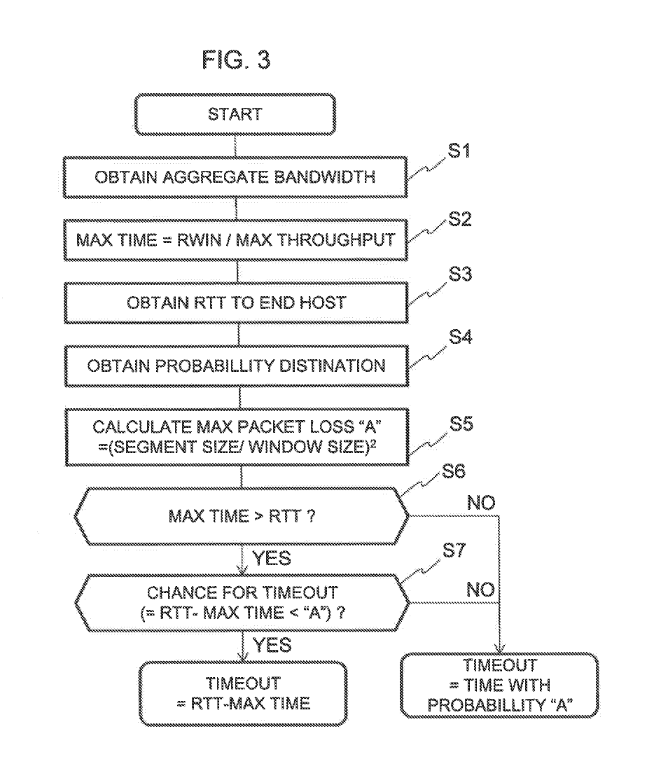

FIG. 3 illustrates an example of the timeout determining process 32A executing by the processor 32. The processor 32 calculates the timeout value for a specific flow. The timeout determining process 32A depicted in FIG. 3 is started when a packet flow between two hosts (e.g. the MT 1 and the end host 6A or 6B) is established or when a packet flow between two hosts is already existent and new information with respect to the delay as mentioned above.

In step S1, the processor 32 obtains the aggregate bandwidth of the flow. The processor 32 may calculate the aggregate bandwidth of the flow by determining the maximum bandwidth available to the flow. For example, the wireless link #1 uses LTE (10 MHz, 64QAM) and the wireless link #2 uses IEEE802.11g, the available bandwidth is 96 Mbit/s (54 Mbit/s+42 Mbit/s). These numbers (bandwidths) are readily available from the specifications of both standards and thus may be readily looked up from a hard-coded table stored in the storage 33 or 34.

In next step S2, the processor 32 calculates the maximum RTT (max time) allowed to attain the maximum aggregate bandwidth with TCP by dividing the setting of Received Window (RWIN) in bits and the maximum throughput calculated in step S1. The maximum RTT is readily available by setting for TCP which is communicated to the end host when setting up the end-to-end connection. A typical value for RWIN is 65536 bytes (=524288 bits). For the maximum aggregate bandwidth of 96 Mbit/s, at least RTT “5.2 ms” is required (524288/100663296=0.00052 s=5.2 ms).

In next step S3, the processor 32 determines the RTT to the other end host. For example, the processor 32 measures the RTT by employing the ping message. When the end host is on the same internal (e.g. the end host 6A), time of 1 or 2 ms is obtained as the RTT easily. When the end host is on the internet (e.g. the end host 6B), it depends on a physical location of the end host what the round trip time is (which can be ranging from typically 10 ms to 500 ms).

In step S4, the processor 32 determines probability distribution for transmitting out of order. This is linked by determining how many packets would be forwarded out of order when using a particular time out setting. For example, if the timeout setting would be 0 ms (i.e. no waiting on other packets) the probability is the same as the number of packets that reach out of order. When using another value, the value represents the number of packets which are forwarded out of order. When increasing the timeout value for packets, the probability decrease while it would not go any lower than the total link packet loss.

In step S5, the processor 32 calculates maximum packet loss “A” (“A” indicates a value). The processor 32 determines the maximum packet loss allowed on a TCP link. The relationship among a throughput, a receive window (RWIN), and round trip time (RTT) is expressed by the formula (1) below.

[Math. 1]

Throughput≦RWIN/RTT (1)

Further, the relationship among a throughput, a segment size (MSS), and a packet loss “PLOSS” is expressed by the formula (2) below.

[Math. 2]

Throughput≦MSS/PTT√P_{LOSS} (2)

Based on the formulae (1) and (2), the packet loss “PLOSS” is calculated by formula (3) below.

[Math. 3]

P_{LOSS}=(MSS/RWIN)² (3)

The packet loss indicates that if the packet loss is higher than the calculated value, the maximum TCP throughput is limited by packet loss and not by RTT. Therefore, it is necessary to keep the packet loss always lower than the packet loss value. In a typical TCP connection with Maximum Segment Size=1500[byte] (with standard Ethernet (registered trademark)) and a windows size 65536, the packet loss is about (1500/65536)2=0.05%.

In step S6, using the probability distribution, the processor 32 checks whether the maximum RTT allowed is larger than the RTT. If this is not the case, then all increased time decrease the maximum throughput and the maximum throughput (even though using link aggregation) cannot be attained. For this reason, the timeout value is set in such way that the out-of-order probability will not exceed the value “A” calculated in the previous step S5 (in the general case 0.05%). When there is a headroom however, the processor 32 go to the next step S6.

In step S7, the processor 32 calculates the out-of-order probability for timeout value “RTT−Max Time.” If the value “RTT−Max Time” is smaller than “A,” the timeout value is set as the value “RTT−Max Time” to allow for as much headroom as possible. When this is not the case however, the timeout value is set to the same value “A” as calculated in the previous step S5.

<Determining the Probability Distribution>

In FIG. 3, step 4 involves obtaining the probability distribution for transmitting out of order. One way to obtain the probability distribution is to look at the characteristics of each wireless technology in use and look at the drop probabilities for each packet. This differs per wireless technology, as some technologies use retransmission technologies (the packet drop results in some added delay due to retransmission, delaying the packets but not dropping them) while others do not (the packet drop results in the packet drop). In LTE, for example, a packet is retransmitted up to 5 times (depends on the setting of the base station). When a transmission error then occurs, the packet is delayed for some additional milliseconds, but it is not dropped. For some wireless technologies, however, there may be no retransmission scheme and thus a delayed packet has a higher chance of being dropped. Using this drop probability then allows to calculate the distribution for transmitting out of order by calculating the chance that a packet is lost after a certain amount of waiting time.

<Determining the Maximum Throughput on an Interface>

In the previous section at step S2, the maximum aggregate throughput of in use wireless links is used to determine the maximum timeout value for a traffic flow. The value is determined by taking the maximum throughput possible on an interface (in case of 10 MHz LTE 42 Mbit/s and IEEE802.11 54 Mbit/s). However, in reality these speeds are almost never obtained due to the overhead of control channels, packet headers and other traffic available on the link. While the maximum speed of a link might be used as an indicator when calculating the timeout value for the first time, it can be adapted to represent the real speed of the flow as observed by LA point 2. The packet flow speed observed at the packet reordering function cannot be used as this flow is affected by the link aggregation speed which could possibly drop if the timeout value is increased.

In the first example of the timeout determining process 32A, the processor 32 calculates the timeout value based on the active measured RTT value using ping packets when a new flow is detected and passive measurements when a packet flow transmits data. It is possible however that ping packets are blocked by the end host. This would prevent the method to obtain an RTT value when a new connection is made. In the second example, the processor 32 determines a “delay” value corresponding to the RTT without using ping packets.

When the IP address of the end host is obtained, the processor 32 determines the raw location of the end host. IP addresses which are in the same subnet as the original transmission is in the local area network and thus have a very low round trip time. IP addresses which are not in the same subnet however, may have a complete different origin. A reversed DNS lookup (DNS (Domain Name System) server) may then provide more information on the location of the end host. If top domain of the DNS is in the same country as the end host, then a relatively low RTT can be expected. When the top domain level indicates that the end-host is very far away, there is a high round trip time to the end host.

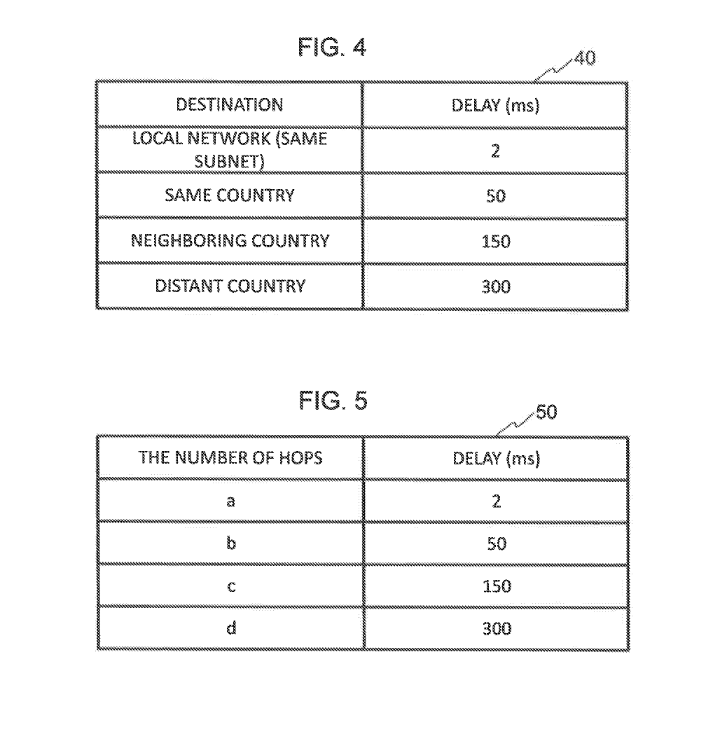

FIG. 4 illustrates an example of table 40 storing destinations and preset delays corresponding to one of the destination. For example, the table 40 is stored in the storage 34. In the delay determining process 32B, the processor 32 determines the destination (location) of the end host based on the IP address of the end host. The processor 32 retrieves a delay corresponding to the destination from the table 40. The processor 32 determines the obtained delay as the delay used in the timeout determination process 32A (step S3 in FIG. 3). Namely, while the local network is determined by looking at the IP address of the end host and checking whether this IP is in the same subnet as the other end host, the other entries are determined based on information on the DNS or IP address of the end host. DNS information can be obtained by using a reverse DNS lookup mechanism or “WHOIS” mechanisms already available.

Next, the third example for determining the timeout value will be explained. FIG. 5 illustrates another example of table 50 storing the number of hops and preset delays corresponding to the number of hops (amount of hops). In FIG. 5, the number of hops is represented by characters “a” to “d”. For example, the table 50 is stored in the storage 34. In the delay determining process 32B, the processor 32 uses the table 50 instead of the table 40. When the IP address of the end host is obtained, the processor measures the number of hops to the end host. For measuring the number of hops, a “traceroute” technique (already known) may be used. The processor 32 retrieves a delay corresponding to the number of hops from the table 50. The processor 32 determines the obtained delay as the delay used in the timeout determination process 32A (step S3 in FIG. 3).

According to the embodiments of the present invention, the timeout value is determined based on the packet loss and the delay such as distance. Therefore, it can avoid problems occurring by using the fixed (universal) timeout value, and influences to upper layers are suppressed.

In the above mentioned embodiment, it is explained that the LAA 3 coupled to the MT 1 via the wireless links #1 and #2. However, the LAA may be coupled to the MT 1 via wired links instead of wireless links, namely, a term of “link(s) may include both of wireless link(s) and wired link(s).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

### REFERENCE SIGNS LIST

1 mobile terminal
2 access point
3 link aggregation apparatus
4 router
5 network
6 end host
31 wireless interface
32 processor
33, 34 storage
35 communication interface
40, 50 table

1. A link aggregation apparatus, comprising:
at least two receiver to receive link aggregated packets from a plurality of links, the link aggregated packets flowing on a packet flow between two end hosts; and
a processor to execute processes including:
determining a delay relating to a remote host within the two end hosts;
reordering the link aggregated packets based on an order in the packet flow; and
calculating a timeout value corresponding to each of the links based on a packet loss and the delay, each timeout value is used to wait reception of a packet from a corresponding link.

2. The link aggregation apparatus according to claim 1, wherein the delay is determined based on a location of the remote host.

3. The link aggregation apparatus according to claim 1, wherein the delay is determined based on whether the remote host is located within a local area network to which the link aggregation apparatus belongs or outside the local area network.

4. The link aggregation apparatus according to claim 1, wherein the delay is determined based on a round trip time to the remote host.

5. The link aggregation apparatus according to claim 1, wherein the delay is determined based on a number of hops to the remote host.

6. A timeout value determining method of a link aggregation apparatus, comprising:
receiving link aggregated packets from a plurality of links, the link aggregated packets flowing on a packet flow between two end hosts;
determining a delay relating to a remote host within the two end hosts;
reordering the link aggregated packets based on an order in the packet flow; and
calculating, by using a processor, a timeout value corresponding to each of the links based on a packet loss and the delay, each timeout value is used to wait reception of a packet from a corresponding link.
